(19) United States
(12) Patent Application Publication
(10) Pub. No.: US 2008/0238720 A1
(43) Pub. Date: Oct. 2, 2008

(54) System And Method For Intelligent Traffic Control Using Wireless Sensor And Actuator Networks

(76) Inventor: Jin-Shyan Lee, Kaohsiung (TW)

Correspondence Address: LIN & ASSOCIATES INTELLECTUAL PROPERTY, INC., P.O. BOX 2339, SARATOGA, CA, 95070-0339, US

(21) Appl. No.: 11/780,477

(22) Filed: Jul. 20, 2007

(30) Foreign Application Priority Data
Mar. 30, 2007 (TW) 096111298

(51) Int. Cl. G08G 1/08; G08G 1/07; G08G 1/095

(52) U.S. Cl. 340/909; 340/910; 340/944; 370/242

(57) ABSTRACT

Disclosed is a system and method for intelligent traffic control using wireless sensor and actuator networks. The system comprises a control center, M regional gateways, and N sensor and actuator nodes. The N sensor and actuator nodes and L cluster heads form L clusters. Each cluster includes a cluster head and at least a sensor and actuator node. The control center, the M regional gateways, and the N sensor and actuator nodes form a multi-layer structure. Each N sensor and actuator node may real-time detect traffic states, and exchange information with other nodes via a wireless communication having a self-recovery function. The system and method applies a distributed computing strategy to automatically adjust the traffic control on each traffic flow, thereby achieving an efficient traffic control.

### FIELD OF THE INVENTION

The present invention generally relates to a system and method for intelligent traffic control using wireless sensor and actuator networks.

### BACKGROUND OF THE INVENTION

The conventional timed traffic control system does not adjust the cycle time of the traffic lights according to the actual traffic flow. It is common for the drivers to wait for a long period of time on the red light even when there is little or no traffic flow in the other direction. It is also common to see a policeman directing the traffic or manually controlling the traffic light to make the traffic flow more efficient.

The modern computerized traffic control system uses sensors on heavy traffic intersections to report the traffic flow information to the traffic control center, which then determines the time for the traffic lights at each intersection. This is called centralized control architecture. The centralized control architecture usually uses the cable for communication among the sensors, traffic lights, light controllers, and traffic control center. The economic and the esthetic cost to the city is high. In addition, because the light control is centralized, it takes more computing time to reach the decision when the traffic states are the intersections are more complicated.

US. Pat. No. 6,710,722 disclosed a traffic light control and information transmission device. As shown in FIG. 1, the device includes a microprocessor 101 installed at the intersection. Microprocessor 101 is connected to a traffic light controller 102, an electronic display board 103, a video camera 104, a compression circuitry 105, and an I/O interface 106. A traffic flow detector 107 is connected to I/O interface 106. I/O interface 106 is connected to a central traffic control computer 111 through a digital subscriber loop (DSL) 108 and a broadband network 109.

The information is transmitted wirelessly between the microprocessor at the intersection and the central traffic control computer through digital subscriber loop (DSL) 108 and broadband network 109. Microprocessor 101 controls the traffic lights and displays the information on electronic display board 103. The traffic flow information at an intersection may be accessed by traffic flow detector 107 and video camera 104, and transmitted to central traffic control computer 111. This device eliminates the cable laying, and reduces the cost.

U.S. Pat. No. 6,633,238 disclosed an intelligent traffic control and warning system and method. The system includes a controller to determine the action according to the traffic congestion parameters. According to the traffic information provided by traffic information unit, the fuzzy logic is used to determine the optimal phase split for the traffic lights. The system and method uses the global positioning system (GPS) to track the moving vehicle and signs for communication.

Other related techniques are also known. See, e.g., U.S. Pat. Nos. 6,317,812, 6,662,099, and 6,989,766. Most techniques use centralized control architecture and uses networks for communicating traffic states and control actions among the central traffic control computer and the intersections, such as via the public switched telephone network (PSTN), cellular packet data (CDPD), or digital subscriber loop (DSL).

The centralized control architecture may be less capable in error tolerance. For example, the malfunction of the traffic control center can lead to the shutdown or malfunctioning of all the connected traffic lights. Also, the above communication method may consume more power because each traffic light controller needs a long distance communication interface.

### SUMMARY OF THE INVENTION

The present disclosure may provide a system and method for intelligent traffic control using wireless sensor and actuator networks. By using wireless communication for traffic information exchange, it may monitor and detect the traffic state. It uses distributed decision-making architecture to achieve effective traffic light control through intersection control in accordance with the actual traffic state.

In one exemplary embodiment, the intelligent traffic control system may comprise a control center, M regional gateways, and N sensor and actuator nodes. The N sensor and actuator nodes and L cluster heads (CH) form L clusters. Each cluster includes a cluster head and at least a sensor and actuator node. The sensor and actuator node is connected to the cluster head. Each cluster head and the neighboring cluster heads may perform inter-cluster communication and inter-cluster cooperative computing. Each regional gateway is connected to the control center. Each regional gateway and its neighboring regional gateways may perform inter-region communication and inter-region cooperative computing. The control center, the M regional gateways, and the N sensor and actuator nodes form a multi-layer structure.

In another exemplary embodiment, the intelligent traffic control method may comprise the steps of forming a multi-layer architecture, the multi-layer architecture including a plurality of regional gateways and a plurality of clusters formed by a plurality of sensor and actuator nodes and a plurality of cluster heads, and each cluster including a cluster head and at least a sensor and actuator node; each cluster head performing autonomic computing, and its corresponding sensor and actuator performing traffic control; each cluster head and its neighboring cluster heads performing cooperative computing and distributed traffic control; each cluster head communicates with its corresponding regional gateway via multi-hop communication, after the corresponding regional gateway performing autonomic computing, the cluster head performing centralized traffic control; each regional gateway and its neighboring regional gateways performing cooperative computing and distributed traffic control; and after a control center communicating with each regional gateway, performing autonomic computing, and each cluster head of a cluster performing centralized traffic control.

The disclosed system forms a multi-layer structure from N sensor and actuator nodes, L cluster heads, and M regional gateways to the control center. The cluster head of a cluster may be any sensor and actuator node of this cluster. Each sensor and actuator node may perform intra-cluster control with the cluster head, and each sensor and actuator node and the cluster head may have an autonomic computing function. Each sensor and actuator node of the cluster may use short distance communication to transmit information with the cluster head.

The cluster head of each cluster and each regional gateway use the multi-hop short distance communication for long distance information transmission. The long distance communication may be used to transmit information between the regional gateways, and between the regional gateway and control center. Each cluster head and each regional gateway have an autonomic computing function.

Therefore, each layer of the system may use the centralized autonomic computing and the distributed cooperative computing. In this manner, even when some nodes, regional gateways, or the traffic control of the control center malfunction, the functioning nodes and regional gateways may still perform the negotiation cooperative computing with other nodes or regional gateways to device a control plan for the neighboring intersections to achieve the fault-tolerant traffic control strategy.

The intelligent traffic control system may use the multi-hop wireless communication for information exchange between regional intersections. Therefore, most sensor and actuator nodes only require a low power short distance communication interface. The long distance communication interface is only installed on some regional gateways. This architecture not only improves the communication reliability, but also reduces the average power consumption at each sensor and actuator node.

The intelligent traffic control system may use the periodical communication between the sensor and actuator nodes to detect whether a sensor and actuator node or a cluster head is functioning, and uses a self-form network to recover the communication capability of the existing sensor and actuator nodes. This self-recovery mechanism allows the system to report on the malfunctioning of a sensor and actuator node or a cluster head, and request for repair.

The intelligent traffic control system and method may be applicable to many situations, such as balance control of the traffic flow, separation of the accident area, and so on. Also, an emergent vehicle (EV) installed with a sensor and actuator device may join the neighboring cluster head, i.e., the system of the present invention, to guide the direction of the EV to shorten the traffic time and accelerate the rescue mission.

The foregoing and other features, aspects and advantages of the present disclosure will become better understood from a careful reading of a detailed description provided herein below with appropriate reference to the accompanying drawings.

### BRIEF DESCRIPTION OF THE DRAWINGS

FIG. 1 is diagram of an exemplary traffic control system and information transmission device.

FIG. 2 is diagram of an exemplary system for intelligent traffic control using wireless sensor and actuator networks, consistent with certain disclosed embodiments.

FIG. 3 is a diagram of an exemplary traffic control strategic sequence of the nodes of each layer, consistent with certain disclosed embodiments.

FIG. 4 is a diagram of an exemplary implementation of a sensor and actuator node, consistent with certain disclosed embodiments.

FIG. 5 shows an exemplary structure and operation of a cluster, consistent with certain disclosed embodiments.

FIG. 6 shows an exemplary operation of a regional gateway, consistent with certain disclosed embodiments.

FIG. 7 shows an example illustrating that each transmission is restricted to K hops when the cluster head communicates with the belonging regional gateway to improve the communication reliability, consistent with certain disclosed embodiments.

FIG. 8 shows an exemplary vehicle sensor and actuator device for an exemplary emergent vehicle guiding system in cooperation with the intelligent traffic control system, consistent with certain disclosed embodiments.

FIG. 9 is an exemplary flow chart illustrating a method for intelligent traffic control using wireless sensor and actuator networks, consistent with certain disclosed embodiments.

FIG. 10A shows an exemplary detection and decision for executing self-recovery when the cluster head is down, consistent with certain disclosed embodiments.

FIG. 10B shows an exemplary self-recovery execution, consistent with certain disclosed embodiments.

FIG. 11 shows an exemplary detection and request for repair when a sensor and actuator node is down, consistent with certain disclosed embodiments.

FIG. 12 shows an exemplary application for balance control of the traffic flow, consistent with certain disclosed embodiments.

FIG. 13 shows an exemplary application for separation control of an accident area, consistent with certain disclosed embodiments.

FIG. 14 and FIG. 15 are exemplary flow charts illustrating the processing of the disclosed embodiments in emergent vehicle guiding.

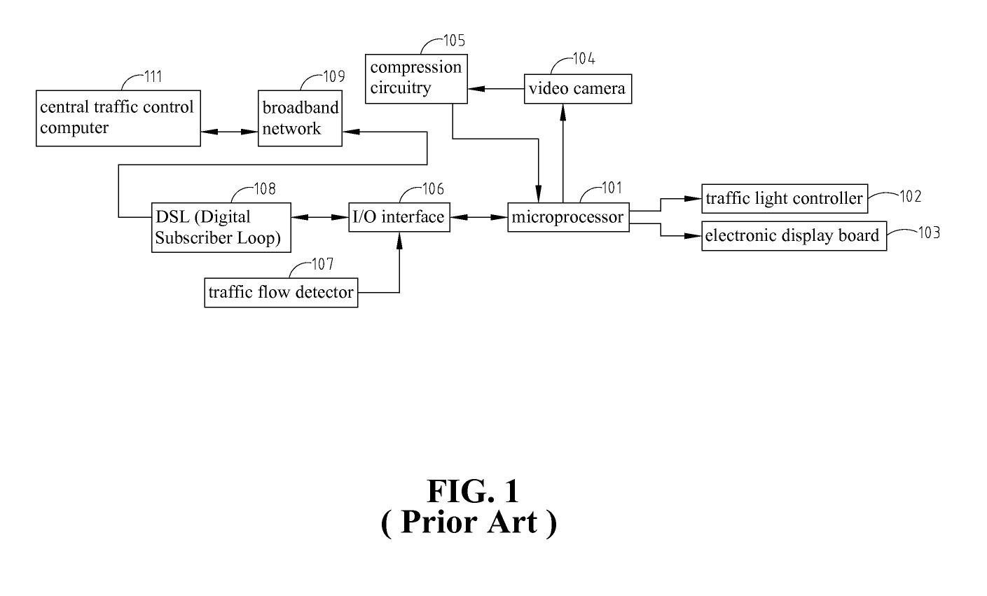

### DETAILED DESCRIPTION OF THE PREFERRED EMBODIMENTS

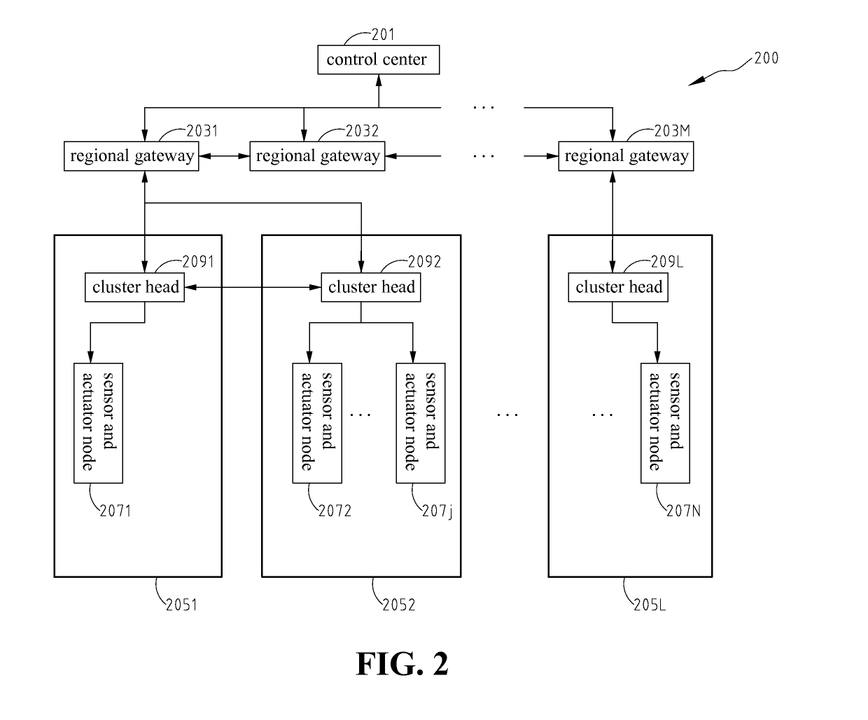

FIG. 2 is diagram of an exemplary system for intelligent traffic control using wireless sensor and actuator networks, consistent with certain disclosed embodiments. Referring to FIG. 2, an intelligent traffic control system 200 may include a control center 201, M regional gateways 2031-203M, and N sensor and actuator nodes 2071-207N. N sensor and actuator nodes 2071-207N and L cluster heads 2091-209L form L clusters 2051-205L. M, N, and L are all positive integers. Each cluster includes a cluster head and at least a sensor and actuator node. The sensor and actuator nodes in a cluster are all connected to the cluster head. Each cluster head may communicate with the cluster heads of the neighboring clusters for inter-cluster cooperative computing. Each regional gateway is connected to control center 201. Each regional gateway may communicate with the neighboring regional gateway for inter-regional cooperative computing.

Through a distributed decision making architecture, system 200 may automatically adjust the control plan of the respective traffic flow and perform traffic control according to the actual traffic state.

From the bottom up, N sensor and actuator nodes 2071-207N, L cluster heads 2091-209L M regional gateways 2031-203M and control center 201 form a multi-layer architecture. For example, the intersections are installed with N sensor and actuator nodes, the roads are installed with L cluster heads, the towns are installed with M regional gateways, and the county is a control center; thus, a multi-layer architecture is formed for the county traffic control.

An intersection may be a cluster, installed with N sensor and actuator nodes, with a cluster head. The cluster head may be a sensor and actuator node responsible for the traffic control of the intersection, single-hop communication with neighboring intersections for cooperative computation, or multi-hop communication with the regional gateway for regional strategic computation. In other words, the multiple clusters (with cluster heads) are installed on the road, and the multiple cluster heads can communicate with each other. The regional gateways are installed in the town, and the control center is at the county center to monitor and control the traffic control system of the entire county. People may also use Internet to access control center or the regional gateway for the updated traffic state.

The control center and the regional gateways may exchange information of the intersections using wired communication or wireless communication, and the cluster heads use wireless communication to communicate with regional gateways. Therefore, the majority of traffic light controllers only require the low power short distance communication interface, and the long distance communication interface is only installed on some regional gateways. In this manner, the actual laying of the cables can be greatly reduced.

As aforementioned, intelligent traffic control system 200 may form a multi-layer architecture. It may also use a distributed strategic computing architecture to adjust a control plan according to the actual traffic state. Therefore, in addition to the centralized autonomic computing capability, the sensor and actuator nodes of each cluster also have the cooperative computing capability. Hence, even when some traffic light controllers or the control center are malfunctioning, the functioning sensor and actuator nodes can still perform negotiation cooperative computing with other clusters or regional gateways to reach a control plan for the neighboring intersections to achieve the fault-tolerant traffic control decision to guarantee the normal operation of the traffic light system.

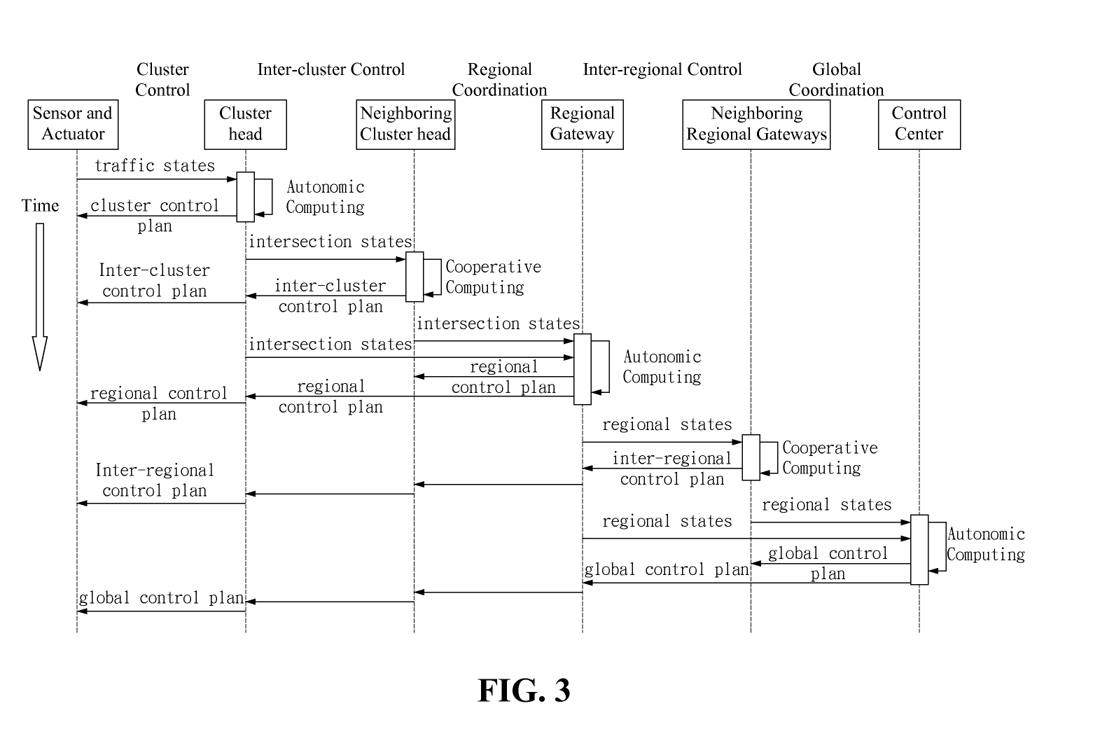

FIG. 3 is a diagram of an exemplary traffic control strategic sequence of the nodes of each layer, consistent with certain disclosed embodiments. For example, referring to FIG. 3, the nodes of each layer may perform autonomic computing or cooperative computing with the neighboring nodes of the same layer to reach the control plan for the intersections. Therefore, in a cluster, the sensor and actuator nodes may perform cluster control with the cluster head of the cluster to carry out the autonomic computing for traffic control targeting intersection according to the regional or intersection traffic states. The cluster heads may perform cooperative computing with the neighboring cluster heads for traffic control targeting each of the intersections on the roads.

Similarly, the cluster heads and the regional gateways may perform autonomic computing to decide the control plan for the town of the regional gateway, and the gateways may perform cooperative computing with neighboring regional gateways to reach the decision on the traffic control of all the intersections in the town.

The choice of autonomic computing or cooperative computing may depend on the obtained information on the regional traffic status, required computing time, and communication reliability. If an immediate reaction to a traffic state, such as accident, is required, or the traffic information required for higher autonomic decision is insufficient, or the communication with the upper layer is unstable, the cooperative computing can be selected, and the decision is more suitable for short term traffic control. For long term traffic control decision, it is more suitable for the high layer control center to obtain the overall traffic states and use the autonomic computing to reach the overall decision on the control plan.

Therefore, the communication between the sensor and actuator node and the cluster head is the short distance communication, and using wireless communication. Also, the communication among cluster heads is short distance communication. The communication between the cluster head and the regional gateway uses the multi-hop short distance communication for regional decision making. Therefore, the cluster head and the regional gateway may perform long distance communication via multi-hop short distance communication. On the other hand, the communications among the regional gateways and between the regional gateway and the control center are long distance communications, and using wired or wireless communication to proceed information exchange on traffic lights and traffic states for each intersection.

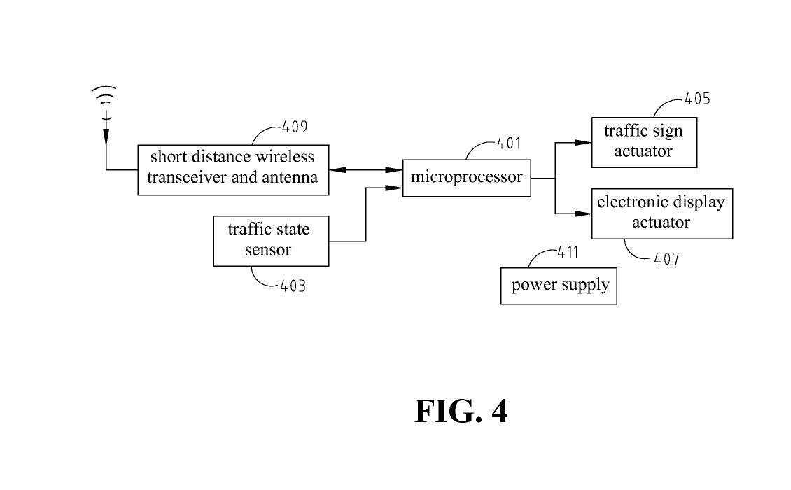

There are several ways to embody the regional gateways and the sensor and actuator nodes in a cluster. FIG. 4 is a diagram of an exemplary implementation of a sensor and actuator node, consistent with certain disclosed embodiments. With the traffic sign control environment on the surface road as an example, the sensor and actuator nodes may be placed on the traffic sign pole at the intersection, and most traffic sign controllers only require low power short distance communication interface. As shown in FIG. 4, the sensor and actuator node includes a microprocessor 401, a traffic state sensor 403, a traffic sign actuator 405, an electronic display actuator 407, a short distance wireless transceiver and antenna 409, and a power supply 411.

Microprocessor 401 controls traffic sign actuator 405 and electronic display actuator 407 according to the information on traffic flow, average number of vehicles, and so on, provided by traffic state sensor 403. Microprocessor 401 also uses short distance wireless transceiver and antenna 409 to connect to other sensor and actuator node for computing and data exchange.

Short distance wireless transceiver and antenna 409 may be implemented with ZigBee, Bluetooth, ultra-wideband (UWB), or Wi-Fi communication protocols for communication interface. Power supply 411 may be from main electrical wire or battery.

The regional gateway requires long distance communication interface, and the function may be similar to that f the sensor and actuator node. Therefore, with a long distance communication interface added to FIG. 4, the regional gateway can be realized. The long distance communication interface may be implemented with GSM/GPRS/3G/WiMAX wireless communication protocols, or Ethernet/DSL wired communication protocols.

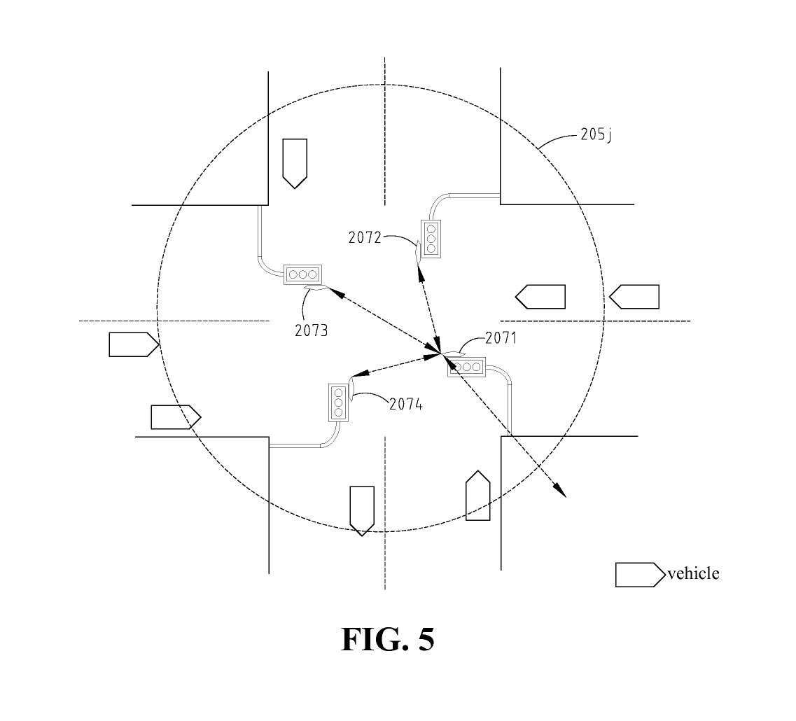

FIG. 5 shows an exemplary structure and operation of a cluster, consistent with certain disclosed embodiments. For example, referring to FIG. 5, a cluster 205j at an intersection may include 4 sensor and actuator nodes 2071-2074. One of the sensor and actuators, say 2071, may be the cluster head (act as the 2091 in FIG. 2), which may be responsible for the traffic control of the intersection.

Cluster head 2071 and other sensor and actuator nodes 2072-2074 of cluster 205j may use the short-distance wireless communication interface for connection. Cluster head 2071 may use single hop communication for cooperative computing with neighboring cluster head. Cluster head 2071 may also use multi-hop communication to communicate with the belonging regional gateway for regional decision making.

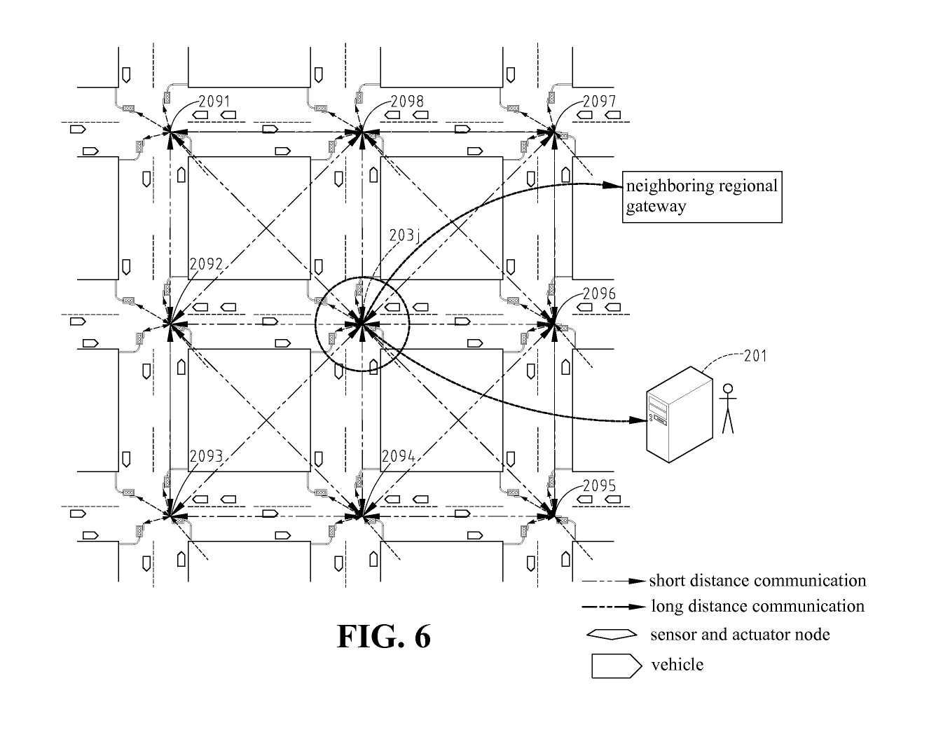

FIG. 6 shows an exemplary operation of a regional gateway, consistent with certain disclosed embodiments. For example, referring to FIG. 6, a regional gateway 203j may be located at the center, and regional gateway 203j may be responsible for the 8 cluster head 2091-2098 of the neighboring intersection. The regional gateway may use mesh network through short distance communication to increase the communication stability. Regional gateway 203j may use long distance communication interface to perform cooperative computing with the neighboring regional gateway 2031 or transmit data to control center 201 so that control center 201 may perform overall decision making. The communication between regional gateway and the neighboring regional gateway or control center 201 may be either wired or wireless.

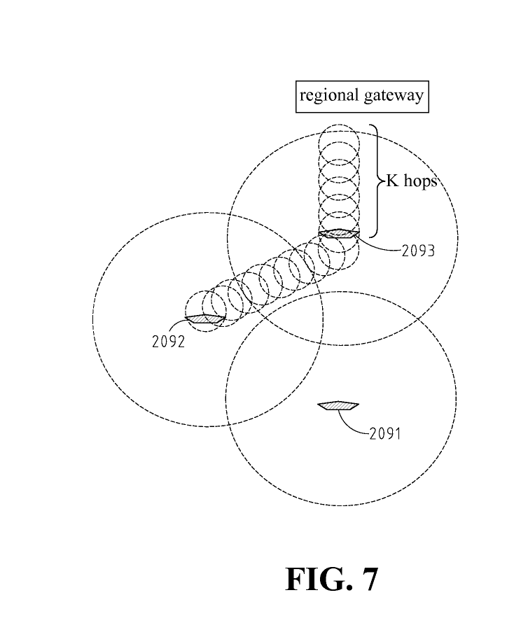

As can be seen from FIG. 7, when cluster head 2091-2093 use multi-hop communication to communicate with the belonging regional gateway, in addition to the mesh network, each transmission is limited to be less than K hops, for example, K=5, to improve the communication reliability. The K value determines the coverage and the number of regional gateways to be placed. It is worth noting that to reduce the frequency interference of the wireless communication, the communication of each layer may use different frequency band. For example, the sensor and actuator nodes within a cluster may use 869/916 MHz band for communication, while the inter-cluster communication may use the 2.4 GHz band to ensure the communication quality.

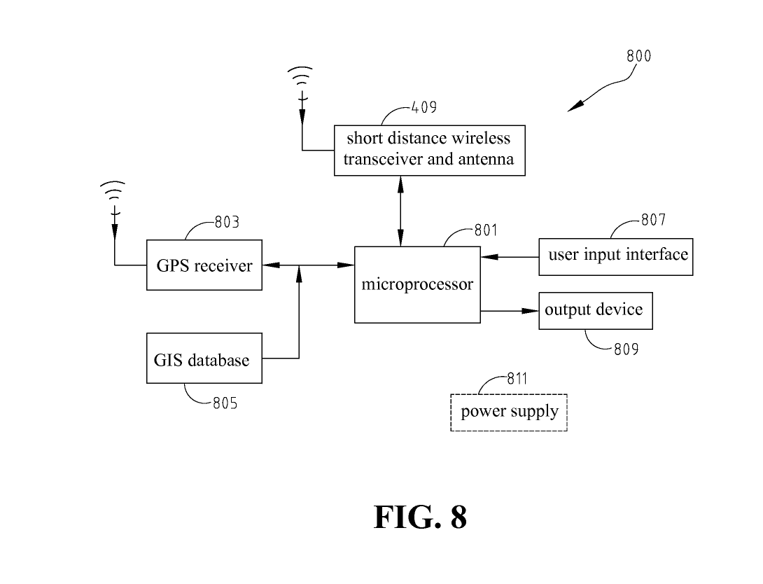

FIG. 8 shows an exemplary vehicle sensor and actuator device for an exemplary emergent vehicle guiding system in cooperation with the intelligent traffic control system, consistent with certain disclosed embodiments. The exemplary sensor and actuator node may be installed inside a vehicle. For example, referring to FIG. 8, a vehicle sensor and actuator device 800 may use a microprocessor 801 to position the current location, i.e., latitude, longitude, and current location map, of the vehicle through GPS receiver 803 and GIS database 805. The vehicle may further communicate with the disclosed sensor and actuator node of the present invention through short distance wireless transceiver and antenna 409 to understand the current traffic state of the intersection. User input interface 807 may be a keyboard, touch screen, or mouse. Output device 809 may be an LCD. Power supply 811 may be electrical wire or battery.

In an exemplary actual application, the sensor and actuator node, vehicle sensor and actuator device, and regional gateway are all independent entities with intelligent agent. Therefore, they have the capability of real-time sensing, communication, coordination and decision making.

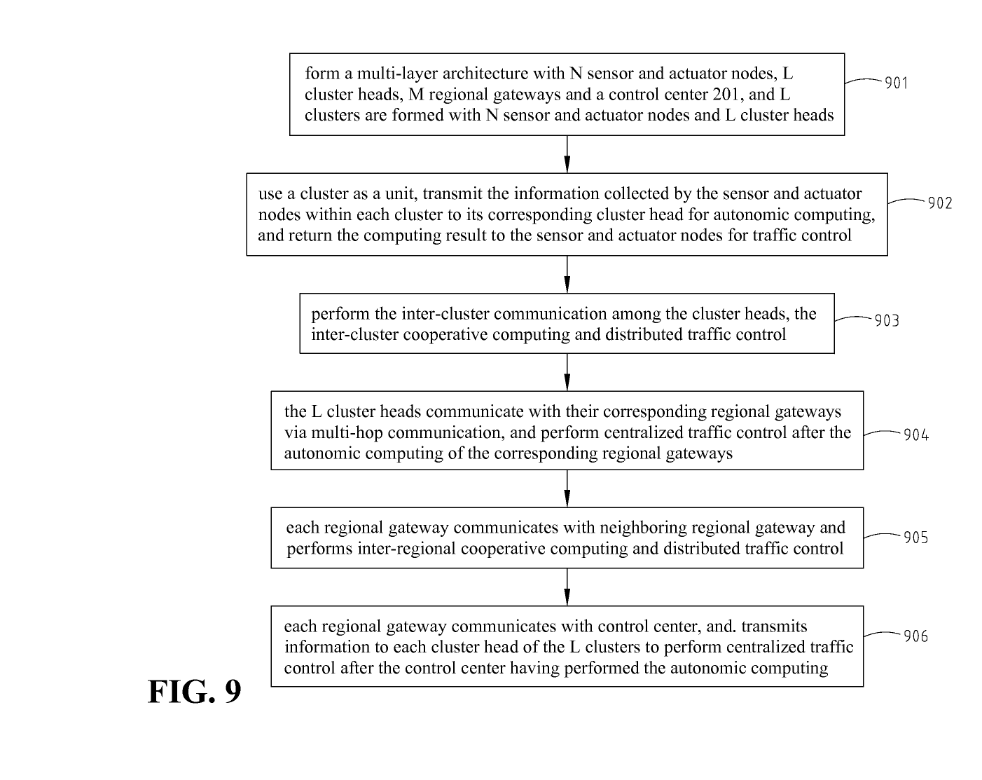

FIG. 9 is an exemplary flow chart illustrating a method for intelligent traffic control using wireless sensor and actuator networks, consistent with certain disclosed embodiments.

For example, referring to FIG. 9, a multi-layer architecture with N sensor and actuator nodes 2071-107N, L cluster heads 2091-209L, M regional gateways 2031-203M and a control center 201 (step 901) is formed. L clusters are formed with N sensor and actuator nodes 2071-207N and L cluster heads 2091-209L.

By using a cluster as a unit, the information collected by the sensor and actuator nodes within each cluster may be transmitted to its corresponding cluster head for autonomic computing, and the computing result may be returned to the sensor and actuator nodes for traffic control, as shown in step 902. The inter-cluster communication among the cluster heads, the inter-cluster cooperative computing and distributed traffic control may be performed, as shown in step 903. The L cluster heads may communicate with their corresponding regional gateways via multi-hop communication. After the autonomic computing of the corresponding regional gateways, the L cluster heads may perform centralized traffic control, as shown in step 904.

Each regional gateway may communicate with neighboring regional gateway and perform inter-regional cooperative computing and distributed traffic control, as shown in step 905. Each regional gateway may communicate with control center. After the control center having performed the autonomic computing, each regional gateway may transmit information to each cluster head of the L clusters to perform centralized traffic control, as shown in step 906.

The following example uses an intersection as a cluster unit for explanation. In step 902, the sensor and actuator nodes of each cluster may detect the traffic state at the intersection, and transmit the condition information to the cluster head for autonomic computing. The cluster head may compute the cycle time for the traffic light of each direction, and transmit the result to the sensor and actual nodes for traffic control.

In step 903, after the exchanging of traffic states of the intersections among the cluster heads, the cluster heads may perform cooperative computing to decide the cycle time of the traffic light of each direction, and transmit the result to the sensor and actuator nodes at each intersection for distributed traffic control.

In step 904, the cluster heads may use multi-hop communication to transmit the traffic state to the regional gateway, the regional gateway may perform autonomic computing after collecting all the traffic information to compute the cycle time for the traffic light of each direction of each intersection, and the results may be transmitted to the cluster heads for centralized traffic control.

In step 905, after the regional gateway exchanges the traffic states with the neighboring regional gateway for cooperative computing, the cycle time of the traffic light of each direction of each intersection may be decided, and transmitted to the cluster head of the intersections for distributed traffic control.

In step 906, each regional gateway may transmit the traffic state to the control center, and the control center may perform autonomic computing to compute the cycle time for each direction of each intersection after collecting all the traffic information. The results may be transmitted to the cluster heads through the regional gateways for centralized traffic control.

The exemplary intelligent traffic control system using wireless sensor and actuator networks, consistent with certain disclosed embodiments, has the self-recovery communication capability. When a cluster head or any sensor and actuator node is down, the existing nodes may still communicate within the cluster or externally. This capability is based on the periodical communication among the sensor and actuator nodes to detect whether a sensor and actuator node is down, and uses self-formed network to recover the communication capability of existing sensor and actuator nodes.

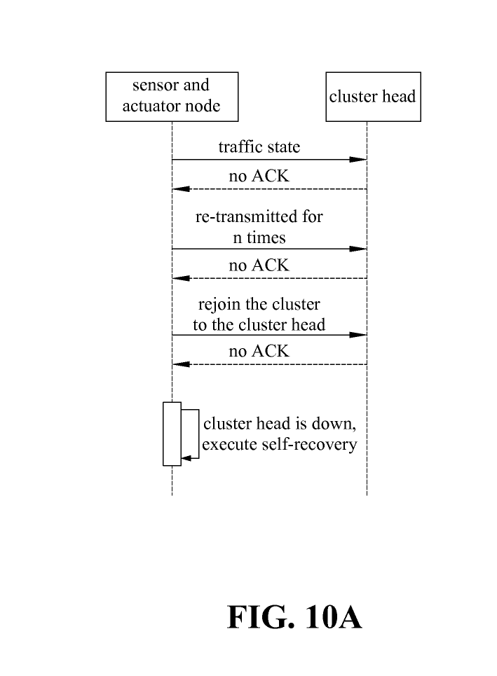

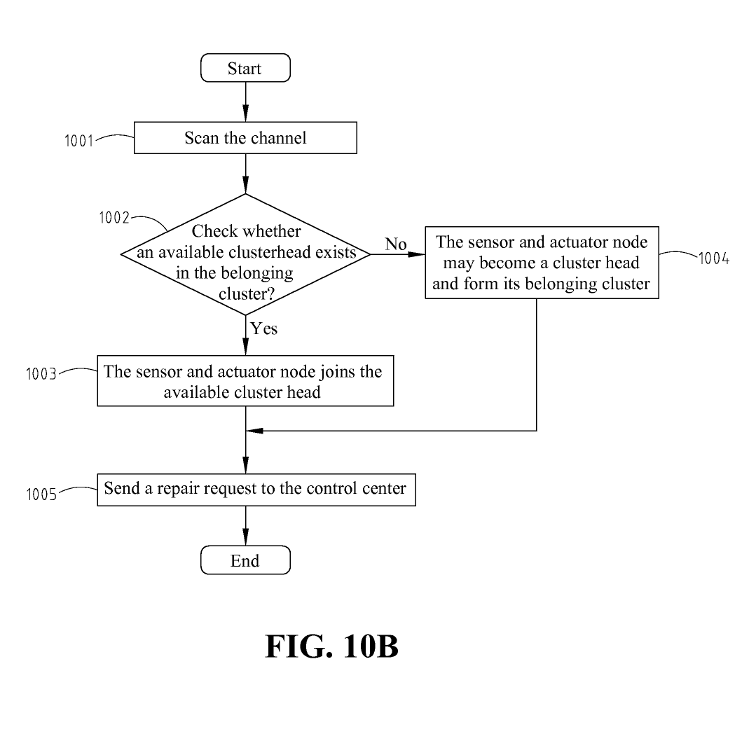

FIG. 10A shows an exemplary detection and decision for executing self-recovery when the cluster head is down, consistent with certain disclosed embodiments. Referring to FIG. 10A, in the cluster, each sensor and actuator node may periodically transmit the real-time traffic state to the cluster head. If a sensor and actuator node does not receive an ACK from the cluster, the traffic state may be re-transmitted for n times, for example, n=10. If no ACK signal is received, the sensor and actuator node may conclude that itself is out of the cluster, and request for rejoining the cluster to the cluster head. If still no ACK signal is received by the sensor and actuator node, the sensor and actuator node may conclude that the cluster head is down, and execute the self-recovery. FIG. 10B shows an exemplary self-recovery execution, consistent with certain disclosed embodiments.

Referring to FIG. 10B, the sensor and actuator node may scan the channel, as shown in step 1001. Whether an available cluster head exists in the belonging cluster may be checked, as shown in step 1002. For example, another sensor and actuator node has already performed the self-recovery and become the new cluster head of the cluster monitoring the same intersection. If so, the sensor and actuator node may join the available cluster head, as shown in step 1003; otherwise, the sensor and actuator node may become a cluster head and form its belonging cluster, as shown in step 1004.

A repair request may also be sent to the control center, as shown in step 1005. For example, the sensor and actuator node, i.e., the new cluster head, may communicate with the belonging regional gateway via the multi-hop communication. The regional gateway may send the repair request to the control center to inform that the original cluster head is down and needs repairing.

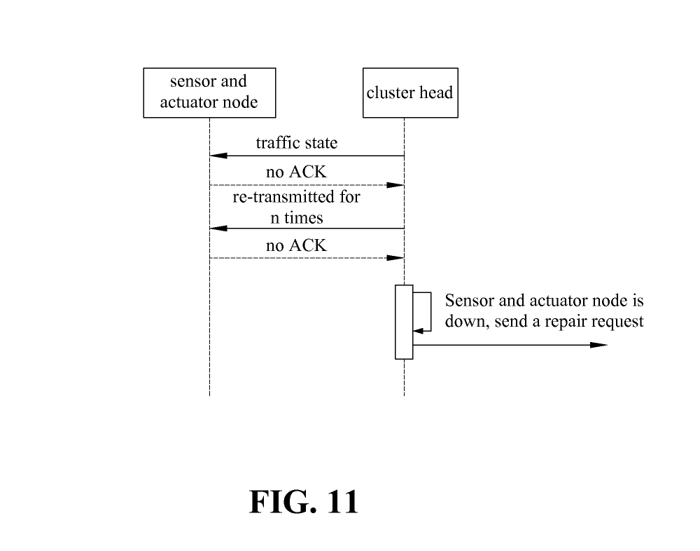

As shown in FIG. 11, in each cluster, the cluster head may also transmit periodically the newest control plan message to each sensor and actuator node within the cluster. If the cluster head does not receive any ACK from a sensor and actuator node, the control plan message may also be retransmitted for n time, for example, n=10. If still no ACK signal is received by the cluster head, the cluster head may conclude that the sensor and actuator node is down, and a repair request may be sent to the control center through multi-hop communication to the belonging regional gateway.

The disclosed embodiments may use the sensor and actuator nodes to periodically sense the real-time traffic state and transmit the condition to each cluster head, or neighboring cluster heads, regional gateways and control center, to perform autonomic or cooperative computing to reach a control plan, and the control plan message may be transmitted to each sensor and actuator node of the intersection to achieve the efficient traffic control.

The following three examples may be used to explain the applications, consistent with certain disclosed embodiments.

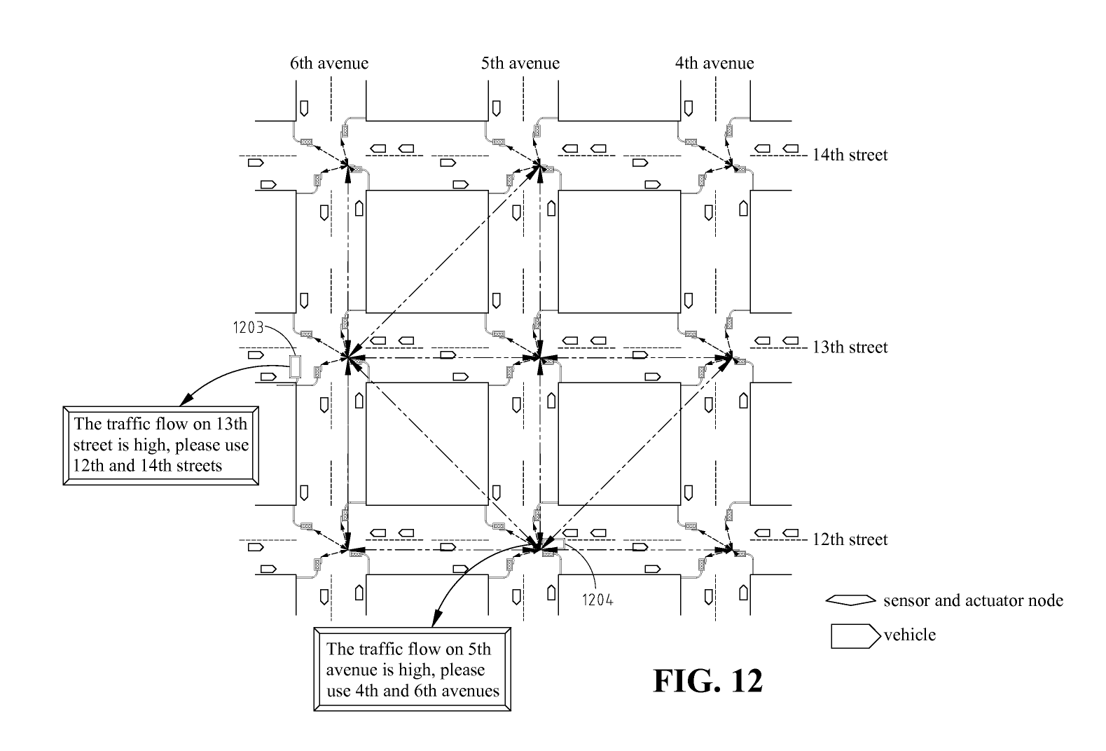

When the disclosed system and method, consistent with certain disclosed embodiments, detects that the traffic flow at some section is high and the flow in neighboring sections is low, it may use wireless network and inform the driver this information prior to entering this section of the road, and recommend an alternative route. FIG. 12 shows an exemplary application for balance control of the traffic flow, consistent with certain disclosed embodiments. Referring to the exemplary application of FIG. 12, the disclosed system and method may monitor the traffic states from the 12^{th} street to the 14^{th} street and from the 4^{th} avenue to the 6^{th} avenue. The disclosed system and method may detect that the traffic flow on 13^{th} street is high, and the neighboring 12^{th} and 14^{th} streets are low, and may display a warning message on an electronic display 1203 before entering 13^{th} street to inform that drivers that the traffic on 13^{th} street is congested, and may advise to use 12^{th} and 14^{th} streets to balance the traffic flow. Similarly, when the traffic flow on 5^{th} avenue is high, electronic display 1204 may be used to recommend the use of 4^{th} avenue or 6^{th} avenue to balance the traffic flow and alleviate the traffic congestion.

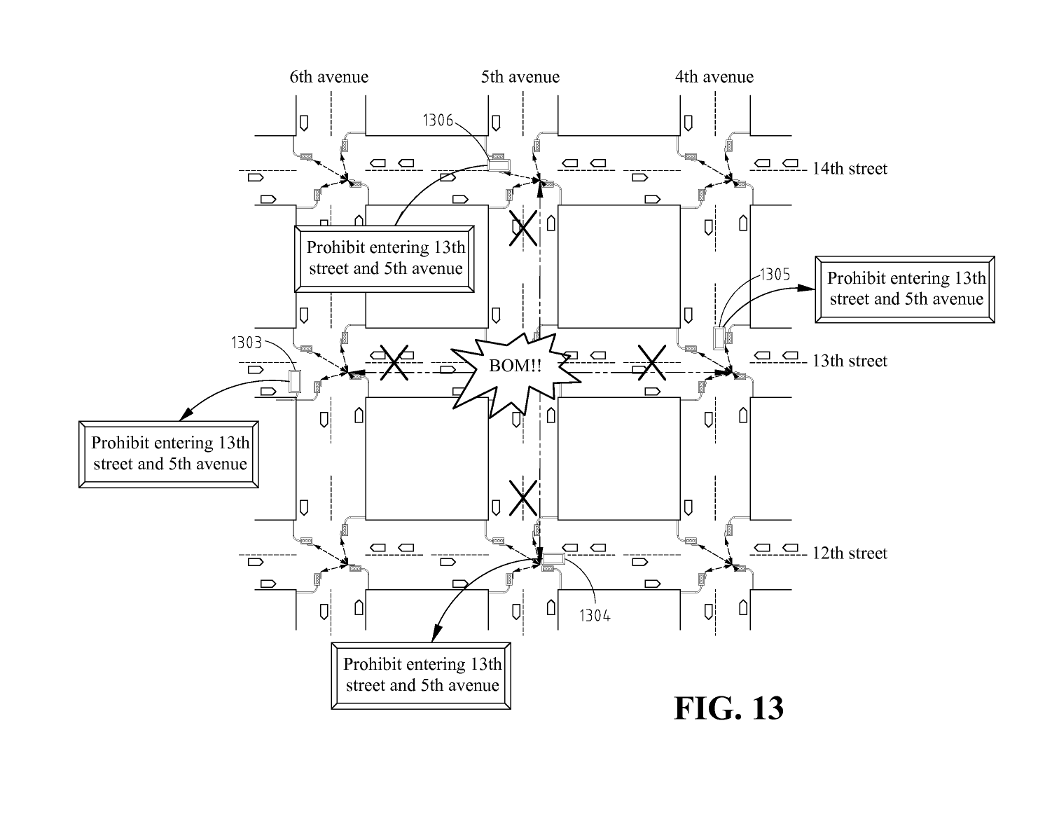

FIG. 13 shows an exemplary application for separation control of an accident area, consistent with certain disclosed embodiments. Referring to the exemplary application of FIG. 13, when the disclosed system, consistent with certain disclosed embodiments, detects an accident, such as car accident or fire, it may control the traffic signs to restrict the access to this area, and use the wireless network to inform the drivers of the situation to avoid entering and causing congestion in the area. For example, the disclosed system detects that a car accident occurred in the area around 13^{th} street and 5^{th} avenue, the electronic displays 1303-1306 on the intersection entering the area may display a warning message to inform the drivers of the accident, and advise detour. The same situation may also be used when a fire is detected to facilitate the rescue mission.

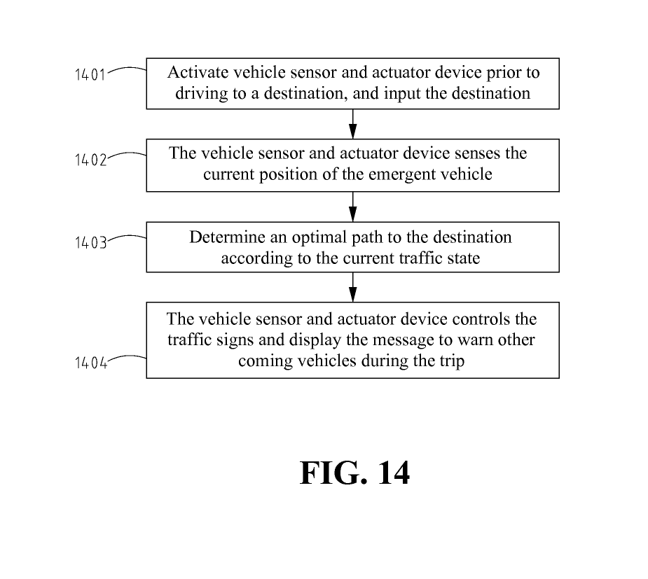

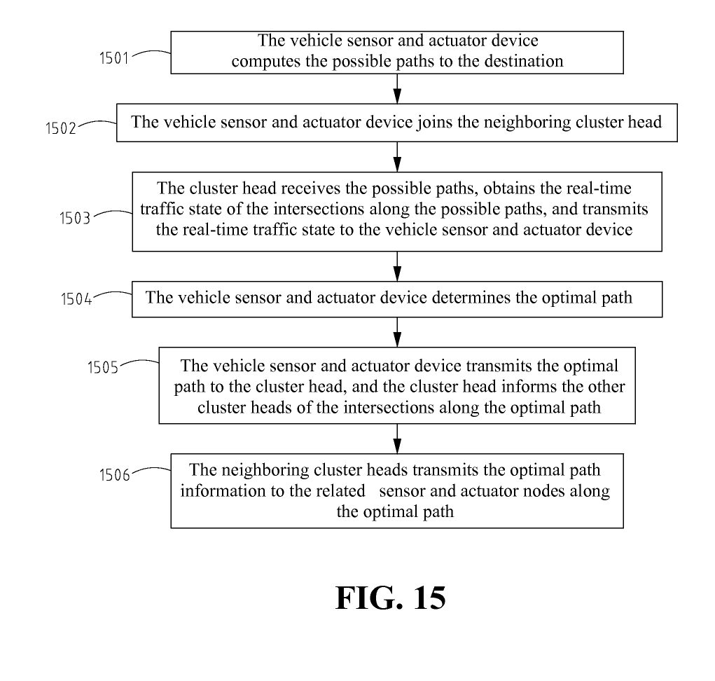

FIG. 14 and FIG. 15 are exemplary flow charts illustrating the processing of the disclosed embodiments in emergent vehicle guiding. Emergent vehicle (EV), such as ambulance, fire engine or police cars, may be equipped with a vehicle sense and actuator node, for example, a sense and actuator node 800 of FIG. 8. Referring to FIG. 14, the EV driver may activate a vehicle sensor and actuator device prior to driving to a destination, and input the destination, as shown in step 1401. In step 1402, the vehicle sensor and actuator device may sense the current position of the emergent vehicle, such as using GPS/GIS. An optimal path to the destination may be determined according to the current traffic state, as shown in step 1403. The vehicle sensor and actuator device may control the traffic signs (via 405 in FIG. 4) and display the message to warn other coming vehicles (via 407 in FIG. 4) during the trip, as shown in step 1404, to accelerate the emergent vehicle to the destination.

The determining in step 1403 of the optimal path to the destination may include the following steps. For example, the vehicle sensor and actuator device may compute the possible paths to the destination, as shown in step 1501. The vehicle sensor and actuator device may also join the neighboring cluster head (i.e. join the disclosed system), and transmit the possible paths to the cluster head, as shown in step 1502.

After the cluster head receives the possible paths, it may obtain the real-time traffic state of the intersections along the possible paths, and transmit the real-time traffic state to the vehicle sensor and actuator device, as shown in step 1503. The vehicle sensor and actuator may determine the optimal path, as shown in step 1504. For example, the optimal path may be the shortest trip time. The vehicle sensor and actuator device may transmit the optimal path to the cluster head, and the cluster head may inform the other cluster heads of the intersections along the optimal path, as shown in step 1505. The neighboring cluster heads may transmit the optimal path information to the related sensor and actuator nodes along the optimal path, as shown in step 1506.

When the emergent vehicle approaches the intersection along the optimal path, the vehicle sensor and actuator may join the cluster head of the intersection. After having confirmed the identification of the emergent vehicle, the traffic sign or electronic display may be controlled to facilitate the passing of the emergent vehicle. For example, turning the traffic light to green for the emergent vehicle. After the emergent vehicle passes the intersection, the intersection may resume the normal operation.

It will be apparent to those skilled in the art that various modifications and variations can be made in the system and method for intelligent traffic control using wireless sensor and actuator network. It is intended that the standard and examples be considered as exemplary only, with a true scope of the disclosed embodiments being indicated by the following claims and their equivalents.

What is claimed is:

1. A system for intelligent traffic control using wireless sensor and actuator networks, said system comprising:
a control center;
M regional gateways, each of said M regional gateways being connected to said control center; and
N sensor and actuator nodes, said N sensor and actuator nodes and L clusters heads forming L clusters, each of said L clusters including a cluster head and at least a sensor and actuator node;
wherein said M, N, and L are positive integers, and said system uses a distributed decision-making architecture to automatically adjust control plan of each intersection for traffic control.

2. The system as claimed in claim 1, wherein each of said L cluster heads communicates with neighboring cluster heads and performs inter-cluster cooperative computing.

3. The system as claimed in claim 1, wherein each of said M regional gateways communicates with neighboring regional gateways and performs inter-regional cooperative computing.

4. The system as claimed in claim 1, wherein each of said N sensor and actuator nodes further includes a microprocessor, a traffic state sensor, a traffic sign actuator, an electronic display actuator, a short distance wireless transceiver and antenna, and a power supply.

5. The system as claimed in claim 1, wherein each of said M regional gateways further includes a microprocessor, a traffic state sensor, a traffic sign actuator, an electronic display actuator, a short distance wireless transceiver and antenna, a power supply, and a long distance communication interface.

6. The system as claimed in claim 1, wherein the cluster head of each cluster is played by a sensor and actuator node of said cluster.

7. The system as claimed in claim 1, wherein each of said N sensor and actuator nodes is installed at an intersection.

8. The system as claimed in claim 1, wherein each sensor and actuator node within a cluster performs cluster control with the cluster head of said cluster, and each said sensor and actuator node and the cluster head of said cluster have an autonomic computing capability.

9. The system as claimed in claim 1, wherein each sensor and actuator node of a cluster communicates with the cluster head of said cluster through short distance communication to exchange information.

10. The system as claimed in claim 1, wherein said system forms a multi-layer architecture from said N sensor and actuator nodes, said L cluster heads, said M regional gateways, to said control center.

11. The system as claimed in claim 10, wherein the cluster head of each cluster uses multi-hop communication for long distance information exchange with its belonging regional gateway.

12. The system as claimed in claim 10, wherein the information exchange among said M regional gateways and between each regional gateway and said control center are performed through long distance communication.

13. The system as claimed in claim 10, wherein among each cluster head in a regional gateway and said regional gateway have an autonomic computing capability.

14. The system as claimed in claim 10, wherein said system uses a vehicle sensor and actuator to handle the real-time guiding for an emergent vehicle.

15. A method for intelligent traffic control using sensor and actuator networks, said method comprising the steps of:
forming a multi-layer architecture, said multi-layer architecture including a plurality of regional gateways and a plurality of clusters formed by a plurality of sensor and actuator nodes and a plurality of cluster heads, and each cluster including a cluster head and at least a sensor and actuator node;
each of said plurality of cluster heads performing autonomic computing, and its corresponding sensor and actuator performing traffic control;
each cluster head and its neighboring cluster heads performing cooperative computing and distributed traffic control;
each cluster head communicates with its corresponding regional gateway via multi-hop communication, after said corresponding regional gateway performing autonomic computing, said cluster head performing centralized traffic control;
each regional gateway and its neighboring regional gateways performing cooperative computing and distributed traffic control; and
after a control center communicating with each regional gateway, performing autonomic computing, and each cluster head of a cluster performing centralized traffic control.

16. The method as claimed in claim 15, wherein said multi-layer architecture is formed from said plurality of sensor and actuator nodes, said plurality of cluster heads, said plurality of regional gateways to said control center.

17. The method as claimed in claim 15, said method has a self-recovery capability.

18. The method as claimed in claim 17, wherein when a cluster head is detected by a sensor and actuator node being down, said self-recovery further includes the steps of:
said sensor and actuator node scanning channel;
checking to determine whether an available cluster head existing in said cluster;
if so, said sensor and actuator node joining said available cluster head;
if not, said sensor and actuator node acting as a cluster head to form a cluster; and
sending a repair request to said control center.

19. The method as claimed in claim 15, wherein when a cluster head of a cluster detects a sensor and actuator node being down, said cluster head uses multi-hop communication to connect its belonging regional gateway and said regional gateway sends a repair request to said control center.

20. The method as claimed in claim 15, said method further includes the handling of real-time guiding of an emergent vehicle.

21. The method as claimed in claim 20, wherein said handling of real-time guiding of said emergent vehicle further includes the steps of:
activating a vehicle sensor and actuator device, and inputting a destination;
said vehicle sensor and actuator device positioning a current location of said emergent vehicle;
determining an optimal path to said destination according to the current real-time traffic state; and
during the trip of said emergent vehicle, said sensor and actuator nodes along said optimal path controlling traffic signs in real time to warn other coming vehicles.

22. The method as claimed in claim 21, wherein said determining an optimal path to said destination steps further includes the steps of:
said vehicle sensor and actuator device computing possible paths to said destination;
said vehicle sensor and actuator device joining a neighboring cluster head, and sending said possible paths to said neighboring cluster head;
said cluster head receiving said possible paths, obtaining real-time traffic state of intersections along said possible paths, transmitting said real-time traffic state to said sensor and actuator device;
said vehicle sensor and actuator device determining an optimal path;
said vehicle sensor and actuator device transmitting said optimal path of said cluster head, and said cluster head informing other cluster heads at the intersections along said optimal path of said optimal path; and
said neighboring cluster head informing said related sensor and actuator nodes of said optimal path information.
